(19) United States
(12) Patent Application Publication
(10) Pub. No.: US 2008/0035672 A1
(43) Pub. Date: Feb. 14, 2008

(54) Selector, Particularly But Not Exclusively, for Beverage Vending Machines

(76) Inventor: Claudio Mestek, Milano (IT)

Correspondence Address: Modiano & Associati, Via Meravigli, 16, Milano, 20123, IT

(21) Appl. No.: 11/665,298

(22) PCT Filed: Oct. 10, 2005
(86) PCT No.: PCT/EP05/10896

§ 371 Date: Apr. 13, 2007

(30) Foreign Application Priority Data
Oct. 25, 2004 (IT) VR2004A000168

(51) Int. Cl. B67D 1/00; B67D 5/06; G07F 13/06

(52) U.S. Cl. 222/144.5

(57) ABSTRACT

A selector particularly but not exclusively for beverage vending machines, comprising a supporting element which is connected, by means of an intake port, to an intake duct and is connected to a plurality of supply ducts by means of a respective supply port, a selection duct being provided which is associated with movement motor and is adapted to connect selectively, as a consequence of the actuation of the movement motor, the intake port to the supply port of one of the supply ducts.

### TECHNICAL FIELD

The present invention relates to a selector suitable particularly but not exclusively to be associated on beverage vending machines.

### BACKGROUND ART

Currently, beverage vending machines have, between the boiler or cold water supply line and the stations for preparing or mixing the beverages, devices for distributing the water to be fed to said preparation stations.

Very often, these distribution devices are constituted by a series of electric valves, which are connected to a supply duct in output from the boiler (or boilers) or the cold water supply line.

Each one of the electric valves has a respective port for feeding a duct which is designed to feed the water to a station for preparing a beverage or in particular to a so-called mixer.

Although these distribution devices are currently widely used, they are not devoid of drawbacks, including, by way of example, the tendency to form limescale, with the consequent need for maintenance and/or replacement of the electric valve.

### DISCLOSURE OF THE INVENTION

The aim of the present invention is to eliminate or at least reduce drastically the drawbacks noted above in known types of selectors.

An object of the present invention is to provide a selector that has a very simple structure and is highly durable.

Another object of the invention is to provide a selector that has a competitive production cost, so that its use is advantageous also from an economical standpoint.

This aim and these and other objects, which will become better apparent hereinafter, are achieved by a selector particularly but not exclusively for beverage vending machines, characterized in that it comprises a supporting element which is connected, by means of an intake port, to an intake duct and is connected to a plurality of supply ducts by means of a respective supply port, a selection duct being provided which is associated with movement means and is adapted to connect selectively, as a consequence of the actuation of said movement means, said intake port to the supply port of one of said supply ducts.

### BRIEF DESCRIPTION OF THE DRAWINGS

Further characteristics and advantages of the invention will become better apparent from the description of some preferred but not exclusive embodiments of a selector according to the invention, illustrated by way of non-limiting example in the accompanying drawings, wherein:

FIG. 1 is a front elevation view of a selector according to the present invention;

FIG. 2 is a side elevation view of the selector shown in FIG. 1;

FIG. 3 is a top elevation view of the selector;

FIG. 4 is a sectional view, taken along the line IV-IV of FIG. 1;

FIG. 5 is an exploded perspective view of the selector;

FIG. 6 is a top view of the selector, similar to the view of FIG. 3;

FIG. 7 is a sectional view of the selector, taken along the plane of arrangement designated by VII-VII of FIG. 6; and

FIG. 8 is an enlarged-scale sectional view of a portion of the selector.

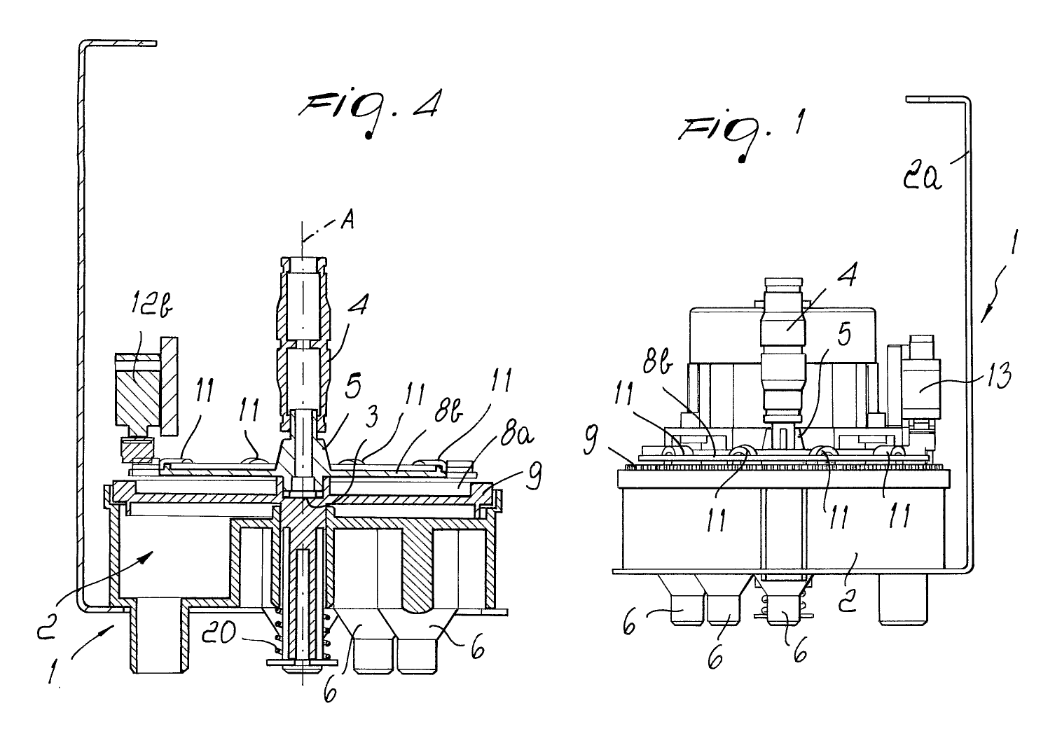

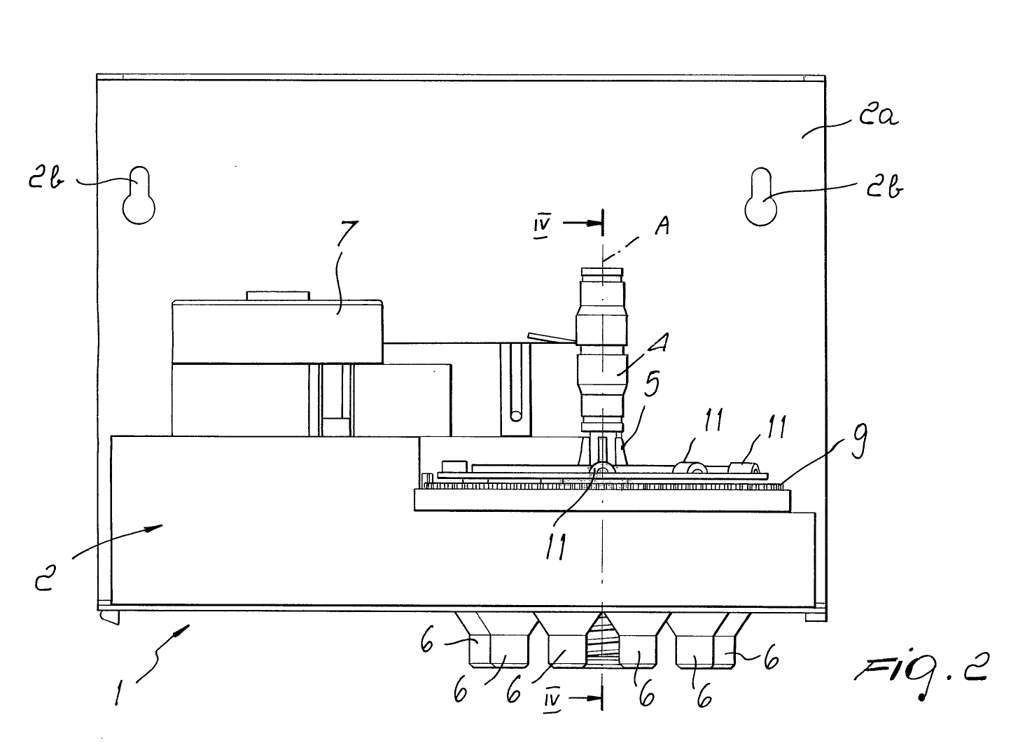

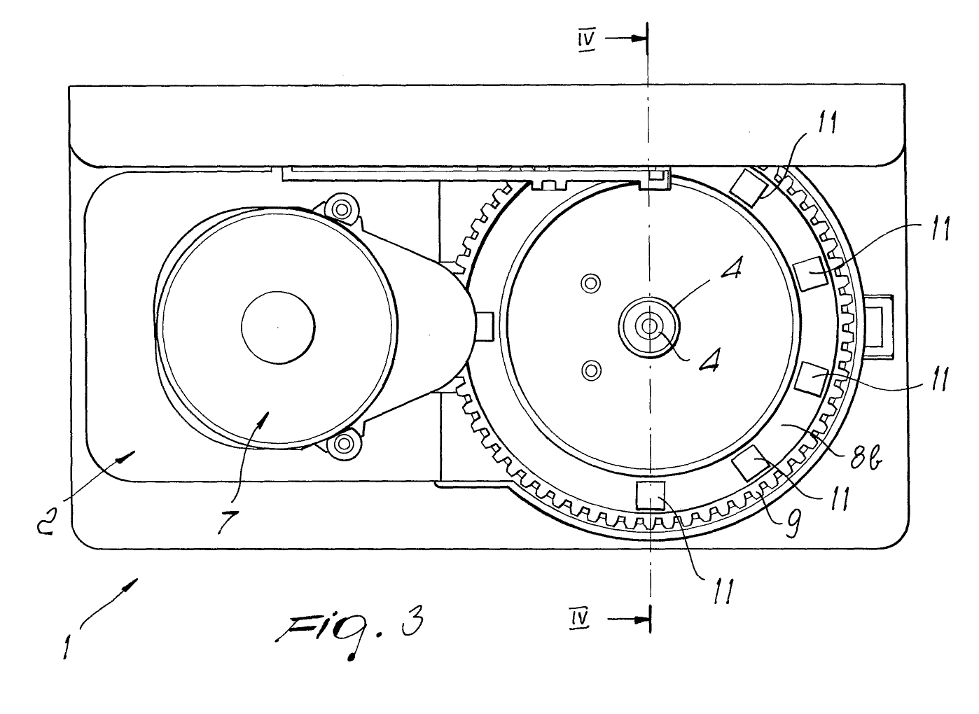

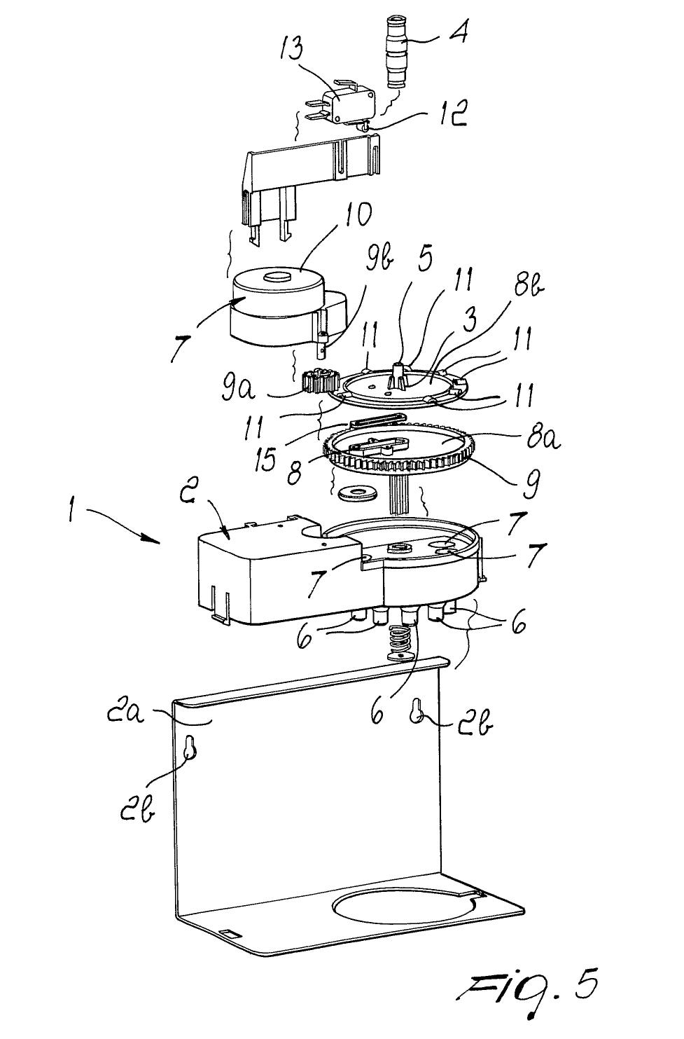

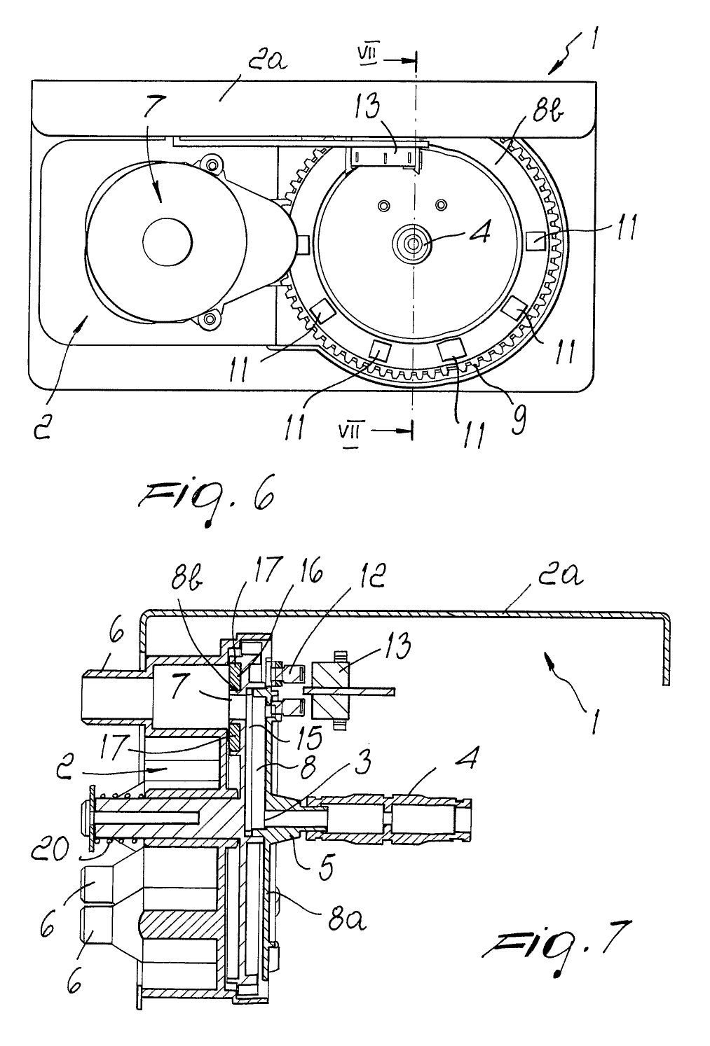

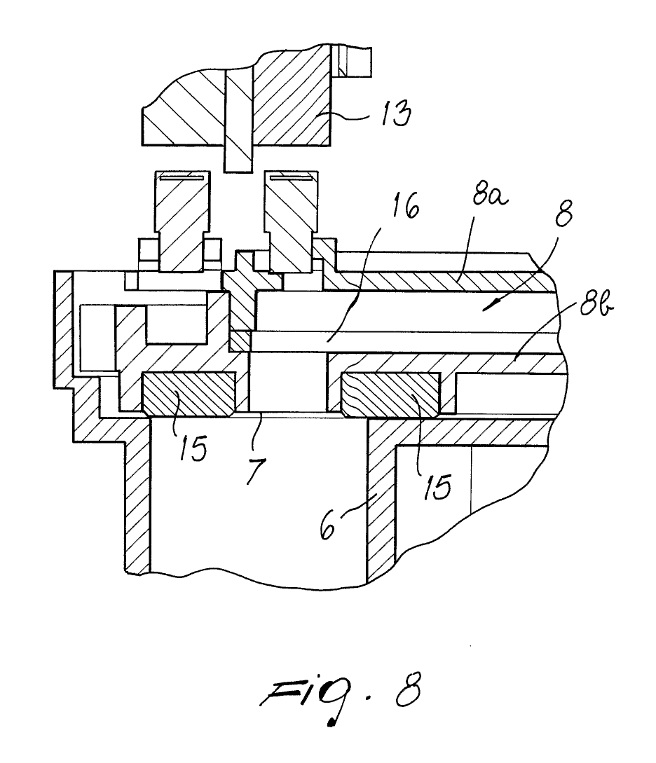

### WAYS OF CARRYING OUT THE INVENTION

In the examples of embodiments that follow, individual characteristics, given in relation to specific examples, may actually be interchanged with other different characteristics that exist in other examples of embodiments.

Moreover, it is noted that anything found to be already known during the patenting process is understood not to be claimed and to be the subject of a disclaimer.

With reference to the figures, a selector particularly but not exclusively for beverage vending machines, generally designated by the reference numeral 1, comprises a supporting element or footing 2.

The supporting element 2 can be associated advantageously with a supporting lamina 2a for fixing, for example by means of fixing slots 2b, the selector 1 to a vertical wall of a vending machine.

The supporting element 2 is connected to an intake duct 4 by means of an intake port 3.

In particular, with reference to the embodiment shown in the figures, the supporting element 2 can be associated with a connector 5, which itself forms the intake port 3 and can be coupled, by means of per se known coupling devices, to the intake duct 4.

In particular, advantageously the coupling between the connector 5 and the intake duct 4 is such as to allow relative rotation about the longitudinal axis of said intake duct 4.

Moreover, the supporting element 2 is connected to a plurality of supply ducts 6 by way of a respective supply port 7.

Advantageously, during use, the supply ports 7 are arranged at a lower level than the intake port 3, so as to allow the liquid (water) to flow from the intake duct 4 to the supply duct 6 by gravity.

According to the present invention, a selection duct 8 is provided, which is associated with movement means 10 and is adapted to connect selectively, as a consequence of the actuation of the movement means 10, the intake port 3 to a respective supply port 7 of one of the supply ducts 6.

In greater detail, the supply ports 7 are arranged along a circular arc, which is substantially centered at the intake port 3, and are angularly spaced, advantageously in a uniform manner.

Conveniently, the selection duct 8 accordingly extends radially from the intake port 3 toward the circular arc formed by the supply ports 7.

Conveniently, the selection duct 8 is supported by a substantially circular element 8a which is associated (in an upward region) with a closure disk 8b, on which the intake port 3 is provided: in particular, the closure disk 8b is connected to the connector 5.

The substantially circular element 8a and the closure disk 8b are rigidly connected so that they are mounted rotatably with respect to the supporting element 2 about a rotation axis which passes through the intake port 3.

Advantageously, there are first sealing means, constituted for example by a first gasket element 15, which are adapted to be interposed between the substantially circular element 8a and the closure disk 8b.

In particular, the first gasket element 15 is inserted in a radial slot on the bottom of the selection duct 8 are so as to ensure the hermetic tightness of said selection duct 8 at the regions for coupling between the substantially circular element 8a and the closure disk 8b.

In particular, the circular element 8a has a movement ring 9, which is connected kinematically to the movement means 10 by way of transmission means or gear system, which can be constituted by a gear 9a, which is connected kinematically to the output shaft 9b of an electric motor which constitutes the movement means 10.

Conveniently, the selection duct 8 has, at the region that is designed to face the supply ports 7, a seat 16 for second sealing means, such as for example a second gasket element 17, which is substantially annular.

Conveniently, both the intake duct 4 and the supply ducts 6 extend along a respective main longitudinal direction, which is substantially parallel to the rotation axis A and perpendicular to the plane of arrangement of the substantially circular element 8a and of the closure disk 8b.

Advantageously, in order to allow correct movement of the selection duct 8, there are means for detecting and controlling the angular movement of the substantially circular element 8a.

According to a preferred embodiment, said detection and control means can be constituted by a plurality of locators 11, which can be detected by a probe 12 associated with a microswitch 13.

Operation of the selector according to the invention is evident from what has been described above.

After positioning the selection duct (or rather, the substantially circular element) in the reset position, depending on the selected beverage, a control unit actuates the movement means until the probe 12 detects the locator 11 that corresponds to the supply duct 6 that must be connected to the intake duct.

In this manner, the correct positioning of the selection duct is achieved simply and effectively.

All the characteristics of the invention described above as being advantageous, convenient or the like may also be omitted or be replaced with equivalents.

Thus, for example, it is possible to provide elastic means 20, which act by traction between the supporting element 2 and the substantially circular element 8a and are adapted to ensure the tightness of the first and second sealing means.

The invention thus conceived is susceptible of numerous modifications and variations, all of which are within the scope of the appended claims.

In practice it has been found that in all the embodiments the invention has achieved the intended aim and objects.

In practice, the materials used, as well as the dimensions, may be any according to requirements.

All the details may further be replaced with other technically equivalent elements.

The disclosures in Italian Patent Application No. VR2004A0001 68 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

What is claimed is:

1-12. (canceled)

13. A selector particularly but not exclusively for beverage vending machines, characterized in that it comprises a supporting element which is connected, by way of an intake port, to an intake duct and is connected to a plurality of supply ducts by way of a respective supply port, a selection duct being provided which is associated with movement means and is adapted to connect selectively, as a consequence of the actuation of said movement means, said intake port to the supply port of one of said supply ducts.

14. The selector according to claim 13, wherein said supply ports are arranged along a circular arc which is substantially centered at said intake port and are angularly spaced, said selection duct extending radially from said intake port toward said circular arc.

15. The selector according to claim 13, wherein said selection duct is supported by a substantially circular element, which is mounted on said supporting element so that it can rotate about a rotation axis which passes through said intake port and is connected kinematically to said movement means.

16. The selector according to claim 15, wherein said intake duct and said plurality of supply ducts lie along a respective main longitudinal direction which is substantially parallel to said rotation axis.

17. The selector according to claim 13, wherein said selection duct comprises a radial slot, which is formed on said substantially circular element, first sealing means being provided which are arranged at said radial slot and are adapted to act between said substantially circular element and a closure element.

18. The selector according to claim 17, wherein said selection duct has, at a region designed to face said supply ports, a seat for second sealing means.

19. The selector according to claim 18, wherein said first sealing means and said second sealing means comprise respectively a first gasket element and a second gasket element.

20. The selector according to claim 13, wherein said movement means comprise an electric motor which is a associated with a movement gear system.

21. The selector according to claim 20, wherein said substantially circular element has an external ring gear, which meshes with said movement gear system.

22. The selector according to claim 15, further comprising means for detecting and controlling an angular movement of said substantially circular element.

23. The selector according to claim 22, wherein said detection and control means comprise a plurality of locators, which are rigidly coupled to said substantially circular element and can be detected by a probe associated with a microswitch.

24. The selector according to claim 18, further comprising elastic means which act by traction between said supporting element and said substantially circular element and are adapted to ensure tightness of said first sealing means and/or of said second sealing means.
